(19) United States
(12) Patent Application Publication
(10) Pub. No.: US 2014/0156349 A1
(43) Pub. Date: Jun. 5, 2014

(54) METHODS AND SYSTEMS FOR MANAGING AN ONLINE OPINION SURVEY SERVICE

(71) Applicant: Dandel Enterprises, Inc., Jamaica Plain, MA (US)

(72) Inventors: Matthew Hill McLoughlin, Boston, MA (US); Noah Seton, Jamaica Plain, MA (US); Kevin Blesy, Boston, MA (US)

(73) Assignee: Dandel Enterprises, Inc., Jamaica Plain, MA (US)

(21) Appl. No.: 14/085,314

(22) Filed: Nov. 20, 2013

Related U.S. Application Data
(60) Provisional application No. 61/732,302, filed on Dec. 1, 2012.

(51) Int. Cl. G06Q 30/02

(52) U.S. Cl. CPC G06Q 30/0203
USPC 705/7.32

(57) ABSTRACT

In one aspect, a method for managing an online survey includes receiving, by a first computing device, from a second computing device, a request to conduct an online survey, the request identifying a requested number of responses and a requested response time. The method includes determining, by the first computing device, a number of panelists to survey, based upon the requested number of responses. The method includes transmitting, by the first computing device, to the determined number of panelists, the survey. The method includes receiving, by the first computing device, from a subset of the determined number of panelists, at least one survey response. The method includes modifying, by the first computing device, the determined number of panelists. The method includes receiving, by the first computing device, responsive to the modification, the requested number of responses and providing the requested number of responses within the requested response time.

### CROSS-REFERENCE TO RELATED APPLICATIONS

This application claims priority from U.S. Patent Application Ser. No. 61/732,302, filed on Dec. 1, 2012, entitled “Methods and Systems for Managing an Online Opinion Survey Service,” which is hereby incorporated by reference.

### BACKGROUND

The disclosure relates to online opinion survey services and the systems designed to provide and facilitate those services. More particularly, the methods and systems described herein relate to functionality for determining how many panelists to survey in order to fulfill clients' order requirements in the most efficient way possible while providing clients with requested results in a timeframe chosen by the clients. Furthermore, the methods and systems described herein relate to functionality for allowing clients to generate customized panels of survey respondents filtered from an overall panel of potential respondents by using demographic, geographic and socio-economic characteristics, and for allowing clients to survey those customized panels.

Many conventional systems for conducting surveys lack functionality for determining how many panelists to survey in order to provide a requested number of responses within a requested response time while minimizing the number of additional survey responses received beyond the requested number. In some of these conventional systems, a survey administrator needs either to collect (and pay for) more survey responses than a client requests or to deny payment to panelists who answer the survey question after a survey request has been satisfied.

### BRIEF SUMMARY

In one aspect, a method for managing an online survey includes receiving, by a first computing device, from a second computing device, a request to conduct an online survey, the request identifying a requested number of responses and a requested response time. The method includes determining, by the first computing device, a number of panelists to survey, based upon the requested number of responses. The method includes transmitting, by the first computing device, to the determined number of panelists, the survey. The method includes receiving, by the first computing device, from a subset of the determined number of panelists, at least one survey response. The method includes modifying, by the first computing device, the determined number of panelists based upon the received at least one survey response. The method includes receiving, by the first computing device, responsive to the modification, the requested number of responses. The method includes providing, by the first computing device, to the second computing device, the requested number of responses within the requested response time.

In another aspect, a method for generating subsequent survey questions in connection with an online opinion survey service includes receiving, by a first computing device, from a second computing device, a request to conduct an online survey, the request identifying a requested number of responses. The method includes determining, by the first computing device, a number of panelists to survey, based upon the requested number of responses. The method includes transmitting, by the first computing device, to the determined number of panelists, the survey. The method includes receiving, by the first computing device, from a subset of the determined number of panelists, at least one survey response. The method includes receiving, by the first computing device, from the second computing device, a subsequent question to the survey based upon the received at least one survey response. The method includes transmitting, by the first computing device, to a second subset of the determined number of panelists, the subsequent question, the second subset identified based upon the received at least one survey response. The method includes providing, by the first computing device to the second computing device, at least one response to the subsequent question from the second subset of the determined number of panelists.

### BRIEF DESCRIPTION OF THE DRAWINGS

The foregoing and other objects, aspects, features, and advantages of the disclosure will become more apparent and better understood by referring to the following description taken in conjunction with the accompanying drawings, in which:

FIGS. 1A-1C are block diagrams depicting embodiments of computers useful in connection with the methods and systems described herein;

FIG. 2A is a block diagram depicting an embodiment of a system for managing an online opinion survey service;

FIG. 2B is a screen shot depicting one embodiment of a user interface for generating a request for an online opinion survey;

FIG. 2C is a screen shot depicting one embodiment of a user interface for specifying a requested response time;

FIG. 2D is a screen shot depicting one embodiment of a user interface for specifying a number of respondents for an online opinion survey;

FIG. 2E is a screen shot depicting one embodiment of a user interface for specifying a requested characteristic for each of a number of surveyed panelists;

FIG. 2F is a screen shot depicting one embodiment of a user interface for indicating a number of available potential panelists satisfying user requests;

FIG. 2G is a screen shot depicting one embodiment of a user interface for creating a customized panel of respondents;

FIG. 2H is a screen shot depicting one embodiment of a user interface in which the user chooses a custom panel of respondents to survey;

FIG. 2I is a screen shot depicting an embodiment of a results file, including a pre-formatted pivot table and analytical tools for analyzing at least one survey result;

FIG. 2J is a screen shot depicting an embodiment of a results file;

FIG. 3A is a flow diagram depicting an embodiment of a method for managing an online opinion survey service; and

FIG. 3B is a flow diagram depicting an embodiment of a method for generating subsequent survey questions in connection with an online opinion survey service.

### DETAILED DESCRIPTION

In some embodiments, the methods and systems described herein provide functionality for managing an online opinion survey service. Before describing these methods and systems in detail, however, a description is provided of a network in which such methods and systems may be implemented.

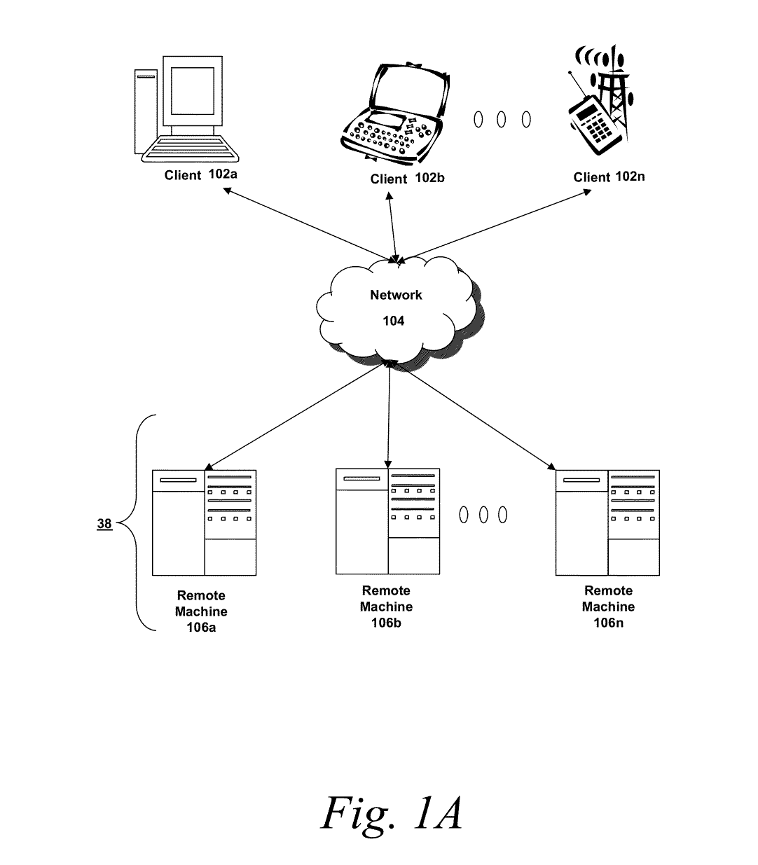

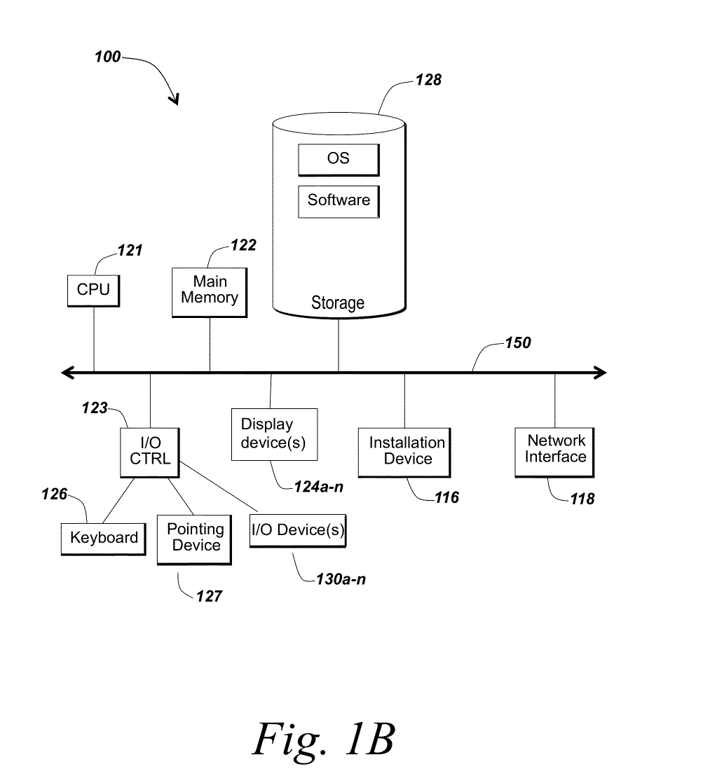

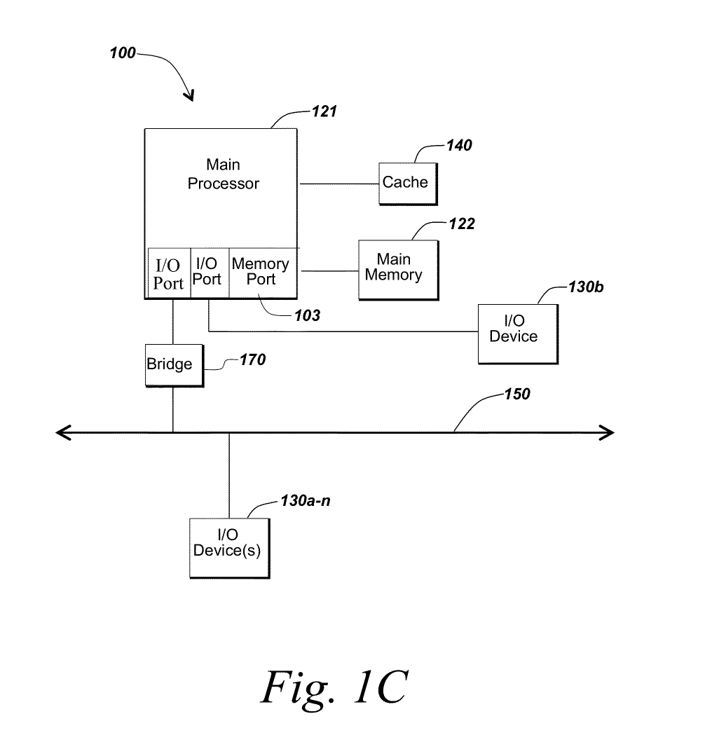

Referring now to FIG. 1A, an embodiment of a network environment is depicted. In brief overview, the network environment comprises one or more clients 102a-102n (also generally referred to as local machine(s) 102, client(s) 102, client node(s) 102, client machine(s) 102, client computer(s) 102, client device(s) 102, computing device(s) 102, endpoint(s) 102, or endpoint node(s) 102) in communication with one or more remote machines 106a-106n (also generally referred to as server(s) 106 or computing device(s) 106) via one or more networks 104.

Although FIG. 1A shows a network 104 between the clients 102 and the remote machines 106, the clients 102 and the remote machines 106 may be on the same network 104. The network 104 can be a local area network (LAN), such as a company Intranet, a metropolitan area network (MAN), or a wide area network (WAN), such as the Internet or the World Wide Web. In some embodiments, there are multiple networks 104 between the clients 102 and the remote machines 106. In one of these embodiments, a network 104′ (not shown) may be a private network and a network 104 may be a public network. In another of these embodiments, a network 104 may be a private network and a network 104′ a public network. In still another embodiment, networks 104 and 104′ may both be private networks.

The network 104 may be any type and/or form of network and may include any of the following: a point to point network, a broadcast network, a wide area network, a local area network, a telecommunications network, a data communication network, a computer network, an ATM (Asynchronous Transfer Mode) network, a SONET (Synchronous Optical Network) network, an SDH (Synchronous Digital Hierarchy) network, a wireless network, and a wireline network. In some embodiments, the network 104 may comprise a wireless link, such as an infrared channel or satellite band. The topology of the network 104 may be a bus, star, or ring network topology. The network 104 may be of any such network topology as known to those ordinarily skilled in the art capable of supporting the operations described herein. The network may comprise mobile telephone networks utilizing any protocol or protocols used to communicate among mobile devices, including AMPS, TDMA, CDMA, GSM, GPRS, or UMTS. In some embodiments, different types of data may be transmitted via different protocols. In other embodiments, the same types of data may be transmitted via different protocols.

A client 102 and a remote machine 106 (referred to generally as computing devices 100) can be any workstation, desktop computer, laptop or notebook computer, server, portable computer, mobile telephone or other portable telecommunication device, media playing device, a gaming system, mobile computing device, or any other type and/or form of computing, telecommunications or media device that is capable of communicating on any type and form of network and that has sufficient processor power and memory capacity to perform the operations described herein. A client 102 may execute, operate or otherwise provide an application, which can be any type and/or form of software, program, or executable instructions, including, without limitation, any type and/or form of web browser, web-based client, client-server application, an ActiveX control, or a Java applet, or any other type and/or form of executable instructions capable of executing on client 102.

In one embodiment, a computing device 106 provides functionality of a web server. In some embodiments, a web server 106 comprises an open-source web server, such as the APACHE servers maintained by the Apache Software Foundation of Delaware. In other embodiments, the web server executes proprietary software, such as the Internet Information Services products provided by Microsoft Corporation of Redmond, Wash., the Oracle iPlanet web server products provided by Oracle Corporation of Redwood Shores, Calif., or the BEA WEBLOGIC products provided by BEA Systems of Santa Clara, Calif.

In some embodiments, the system may include multiple, logically-grouped remote machines 106. In one of these embodiments, the logical group of remote machines may be referred to as a server farm 38. In another of these embodiments, the server farm 38 may be administered as a single entity.

FIGS. 1B and 1C depict block diagrams of a computing device 100 useful for practicing an embodiment of the client 102 or a remote machine 106. As shown in FIGS. 1B and 1C, each computing device 100 includes a central processing unit 121, and a main memory unit 122. As shown in FIG. 1B, a computing device 100 may include a storage device 128, an installation device 116, a network interface 118, an I/O controller 123, display devices 124a-n, a keyboard 126, a pointing device 127, such as a mouse, and one or more other I/O devices 130a-n. The storage device 128 may include, without limitation, an operating system and software. As shown in FIG. 1C, each computing device 100 may also include additional optional elements, such as a memory port 103, a bridge 170, one or more input/output devices 130a-130n (generally referred to using reference numeral 130), and a cache memory 140 in communication with the central processing unit 121.

The central processing unit 121 is any logic circuitry that responds to and processes instructions fetched from the main memory unit 122. In many embodiments, the central processing unit 121 is provided by a microprocessor unit, such as: those manufactured by Intel Corporation of Mountain View, Calif.; those manufactured by Motorola Corporation of Schaumburg, Ill.; those manufactured by Transmeta Corporation of Santa Clara, Calif.; those manufactured by International Business Machines of White Plains, N.Y.; or those manufactured by Advanced Micro Devices of Sunnyvale, Calif. The computing device 100 may be based on any of these processors, or any other processor capable of operating as described herein.

Main memory unit 122 may be one or more memory chips capable of storing data and allowing any storage location to be directly accessed by the microprocessor 121. The main memory 122 may be based on any available memory chips capable of operating as described herein. In the embodiment shown in FIG. 1B, the processor 121 communicates with main memory 122 via a system bus 150. FIG. 1C depicts an embodiment of a computing device 100 in which the processor communicates directly with main memory 122 via a memory port 103. FIG. 1C also depicts an embodiment in which the main processor 121 communicates directly with cache memory 140 via a secondary bus, sometimes referred to as a backside bus. In other embodiments, the main processor 121 communicates with cache memory 140 using the system bus 150.

In the embodiment shown in FIG. 1B, the processor 121 communicates with various I/O devices 130 via a local system bus 150. Various buses may be used to connect the central processing unit 121 to any of the I/O devices 130, including a VESA VL bus, an ISA bus, an EISA bus, a MicroChannel Architecture (MCA) bus, a PCI bus, a PCI-X bus, a PCI-Express bus, or a NuBus. For embodiments in which the I/O device is a video display 124, the processor 121 may use an Advanced Graphics Port (AGP) to communicate with the display 124. FIG. 1C depicts an embodiment of a computer 100 in which the main processor 121 also communicates directly with an I/O device 130b via, for example, HYPERTRANSPORT, RAPIDIO, or INFINIBAND communications technology.

A wide variety of I/O devices 130a-130n may be present in the computing device 100. Input devices include keyboards, mice, trackpads, trackballs, microphones, scanners, cameras, and drawing tablets. Output devices include video displays, speakers, inkjet printers, laser printers, and dye-sublimation printers. The I/O devices may be controlled by an I/O controller 123 as shown in FIG. 1B. Furthermore, an I/O device may also provide storage and/or an installation medium 116 for the computing device 100. In some embodiments, the computing device 100 may provide USB connections (not shown) to receive handheld USB storage devices such as the USB Flash Drive line of devices manufactured by Twintech Industry, Inc. of Los Alamitos, Calif.

Referring still to FIG. 1B, the computing device 100 may support any suitable installation device 116, such as a floppy disk drive for receiving floppy disks such as 3.5-inch, 5.25-inch disks or ZIP disks, a CD-ROM drive, a CD-R/RW drive, a DVD-ROM drive, tape drives of various formats, USB device, hard-drive, or any other device suitable for installing software and programs. The computing device 100 may further comprise a storage device, such as one or more hard disk drives or redundant arrays of independent disks, for storing an operating system and other software.

Furthermore, the computing device 100 may include a network interface 118 to interface to the network 104 through a variety of connections including, but not limited to, standard telephone lines, LAN or WAN links (e.g., 802.11, T1, T3, 56kb, X.25, SNA, DECNET), broadband connections (e.g., ISDN, Frame Relay, ATM, Gigabit Ethernet, Ethernet-over-SONET), wireless connections, or some combination of any or all of the above. Connections can be established using a variety of communication protocols (e.g., TCP/IP, IPX, SPX, NetBIOS, Ethernet, ARCNET, SONET, SDH, Fiber Distributed Data Interface (FDDI), RS232, IEEE 802.11, IEEE 802.11a, IEEE 802.11b, IEEE 802.11g, IEEE 802.11n, CDMA, GSM, SS7, WiMax, and direct asynchronous connections). In one embodiment, the computing device 100 communicates with other computing devices 100′ via any type and/or form of gateway or tunneling protocol such as Secure Socket Layer (SSL) or Transport Layer Security (TLS). In some embodiments, the computing device 100 provides communications functionality including services such as those in compliance with the Global System for Mobile Communications (GSM) standard or other short message services (SMS). The network interface 118 may comprise a built-in network adapter, network interface card, PCMCIA network card, card bus network adapter, wireless network adapter, USB network adapter, modem, or any other device suitable for interfacing the computing device 100 to any type of network capable of communication and performing the operations described herein.

In some embodiments, the computing device 100 may comprise or be connected to multiple display devices 124a-124n, each of which may be of the same or different type and/or form. As such, any of the I/O devices 130a-130n and/or the I/O controller 123 may comprise any type and/or form of suitable hardware, software, or combination of hardware and software to support, enable, or provide for the connection and use of multiple display devices 124a-124n by the computing device 100. One ordinarily skilled in the art will recognize and appreciate the various ways and embodiments that a computing device 100 may be configured to have multiple display devices 124a-124n.

In further embodiments, an I/O device 130 may be a bridge between the system bus 150 and an external communication bus, such as a USB bus, an Apple Desktop Bus, an RS-232 serial connection, a SCSI bus, a FireWire bus, a FireWire 800 bus, an Ethernet bus, an AppleTalk bus, a Gigabit Ethernet bus, an Asynchronous Transfer Mode bus, a HIPPI bus, a Super HIPPI bus, a SerialPlus bus, a SCI/LAMP bus, a FibreChannel bus, or a Serial Attached small computer system interface bus.

A computing device 100 of the sort depicted in FIGS. 1B and 1C typically operates under the control of operating systems, which control scheduling of tasks and access to system resources. The computing device 100 can be running any operating system such as any of the versions of the MICROSOFT WINDOWS operating systems, the different releases of the Unix and Linux operating systems, any version of the MAC OS for Macintosh computers, any embedded operating system, any real-time operating system, any open source operating system, any proprietary operating system, any operating systems for mobile computing devices, or any other operating system capable of running on the computing device and performing the operations described herein. Typical operating systems include, but are not limited to: WINDOWS 3.x, WINDOWS 95, WINDOWS 98, WINDOWS 2000, WINDOWS NT 3.51, WINDOWS NT 4.0, WINDOWS CE, WINDOWS XP, WINDOWS 7, and WINDOWS VISTA, all of which are manufactured by Microsoft Corporation of Redmond, Wash.; MAC OS manufactured by Apple Inc. of Cupertino, Calif.; OS/2 manufactured by International Business Machines of Armonk, N.Y.; and Linux, a freely-available operating system distributed by Caldera Corp. of Salt Lake City, Utah, or any type and/or form of a Unix operating system, among others.

The computing device 100 can be any workstation, desktop computer, laptop or notebook computer, server, portable computer, mobile telephone or other portable telecommunication device, media playing device, a gaming system, mobile computing device, or any other type and/or form of computing, telecommunications, or media device that is capable of communication and that has sufficient processor power and memory capacity to perform the operations described herein. In some embodiments, the computing device 100 may have different processors, operating systems, and input devices consistent with the device. In other embodiments the computing device 100 is a mobile device, such as a JAVA-enabled cellular telephone or personal digital assistant (PDA). The computing device 100 may be a mobile device such as those manufactured, by way of example and without limitation, by Motorola Corp. of Schaumburg, Ill.; Kyocera of Kyoto, Japan; Samsung Electronics Co., Ltd. of Seoul, Korea; Nokia of Finland; Hewlett-Packard Development Company, L.P. and/or Palm, Inc., of Sunnyvale, Calif.; Sony Ericsson Mobile Communications AB of Lund, Sweden; or Research In Motion Limited of Waterloo, Ontario, Canada. In yet other embodiments, the computing device 100 is a smart phone, Pocket PC, Pocket PC Phone, or other portable mobile device supporting Microsoft Windows Mobile Software.

In some embodiments, the computing device 100 is a digital audio player. In one of these embodiments, the computing device 100 is a digital audio player such as the Apple IPOD, IPOD Touch, IPOD NANO, and IPOD SHUFFLE lines of devices manufactured by Apple Inc. of Cupertino, Calif. In another of these embodiments, the digital audio player may function as both a portable media player and as a mass storage device. In other embodiments, the computing device 100 is a digital audio player such as those manufactured by, for example and without limitation, Samsung Electronics America of Ridgefield Park, N.J., Motorola Inc. of Schaumburg, Ill., or Creative Technologies Ltd. of Singapore. In yet other embodiments, the computing device 100 is a portable media player or digital audio player supporting file formats including, but not limited to, MP3, WAV, M4A/AAC, WMA Protected AAC, AEFF, Audible audiobook, Apple Lossless audio file formats, and .mov, .m4v, and .mp4 MPEG-4 (H.264/MPEG-4 AVC) video file formats.

In some embodiments, the computing device 100 comprises a combination of devices, such as a mobile phone combined with a digital audio player or portable media player. In one of these embodiments, the computing device 100 is a device in the Motorola line of combination digital audio players and mobile phones. In another of these embodiments, the computing device 100 is a device in the iPhone smartphone line of devices manufactured by Apple Inc. of Cupertino, Calif. In still another of these embodiments, the computing device 100 is a device executing the Android open source mobile phone platform distributed by the Open Handset Alliance; for example, the device 100 may be a device such as those provided by Samsung Electronics of Seoul, Korea, or HTC Headquarters of Taiwan, R.O.C. In other embodiments, the computing device 100 is a tablet device such as, for example and without limitation, the iPad line of devices manufactured by Apple Inc.; the PlayBook manufactured by Research in Motion; the Cruz line of devices manufactured by Velocity Micro, Inc. of Richmond, Va.; the Folio and Thrive line of devices manufactured by Toshiba America Information Systems, Inc. of Irvine, Calif.: the Galaxy line of devices manufactured by Samsung; the HP Slate line of devices manufactured by Hewlett-Packard; and the Streak line of devices manufactured by Dell, Inc. of Round Rock, Tex.

In some embodiments, an infrastructure may extend from a first network—such as a network owned and managed by an individual or an enterprise—into a second network, which may be owned or managed by a separate entity than the entity owning or managing the first network. Resources provided by the second network may be said to be “in a cloud.” Cloud-resident elements may include, without limitation, storage devices, servers, databases, computing environments (including virtual machines, servers, and desktops), and applications. For example, an administrator of a machine 106a on a first network may use a remotely located data center to store servers 106b-n (including, for example, application servers, file servers, databases, and backup servers), routers, switches, and telecommunications equipment. The data center may be owned and managed by the administrator of the machine 106a on the first network or a third-party service provider (including for example, a cloud services and hosting infrastructure provider) may provide access to a separate data center.

In some embodiments, a system in which users of a first network access at least a second network including a pool of abstracted, scalable, and managed computing resources capable of hosting resources may be referred to as a cloud computing environment. In other embodiments, resources may include, without limitation, virtualization technology, data center resources, applications, and management tools. In still other embodiments, Internet-based applications (which may be provided via a “software-as-a-service” model) may be referred to as cloud-based resources. In other embodiments, networks that provide users with computing resources, such as remote servers, virtual machines, or blades on blade servers, may be referred to as compute clouds or “infrastructure-as-a-service” providers. In still other embodiments, networks that provide storage resources, such as storage area networks, may be referred to as storage clouds. In further embodiments, a resource may be cached in a local network and stored in a cloud.

In some embodiments, some or all of a plurality of remote machines 106 may be leased or rented from third-party companies such as, by way of example and without limitation, Amazon Web Services LLC, of Seattle, Wash.; Rackspace US, Inc., of San Antonio, Tex.; Microsoft Corporation of Redmond, Wash.; and Google Inc., of Mountain View, Calif. In other embodiments, all the hosts 106 are owned and managed by third-party companies including, without limitation, Amazon Web Services LLC, Rackspace US, Inc., Microsoft, and Google. Other providers of cloud-based resources may include, without limitation, salesforce.com, Inc., of San Francisco, Calif., and Facebook, Inc., of Menlo Park, Calif.

In some embodiments, the methods and systems described herein provide functionality for managing an online opinion survey service. More particularly, the method relates to functionality for determining how many panelists should receive a given survey question in order to fulfill a client's survey request efficiently while providing the client with its requested results in the specific timeframe chosen by the client. Furthermore, the methods and systems described herein relate to functionality for allowing clients to customize and save panels of survey respondents filtered from the overall panel of potential respondents by using demographic, geographic and socio-economic characteristics, and for allowing clients to survey those customized panels. In one embodiment, implementing the methods and systems described herein results in minimizing the number of additional surveys completed beyond a client's request and in minimizing the total compensation expense for the survey administrator while compensating panelists for answering a survey question within a stated time period, thus creating an improved user experience for clients and panelists alike.

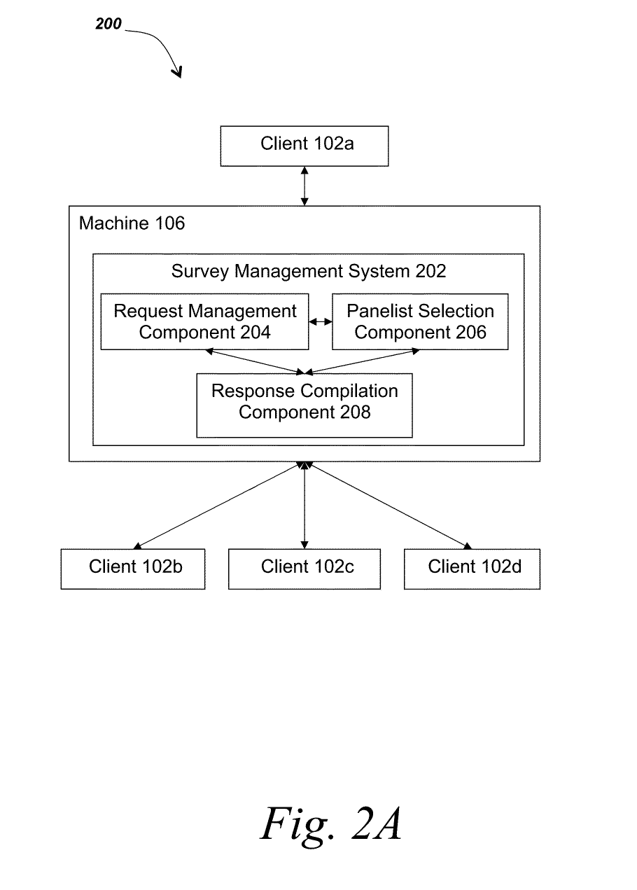

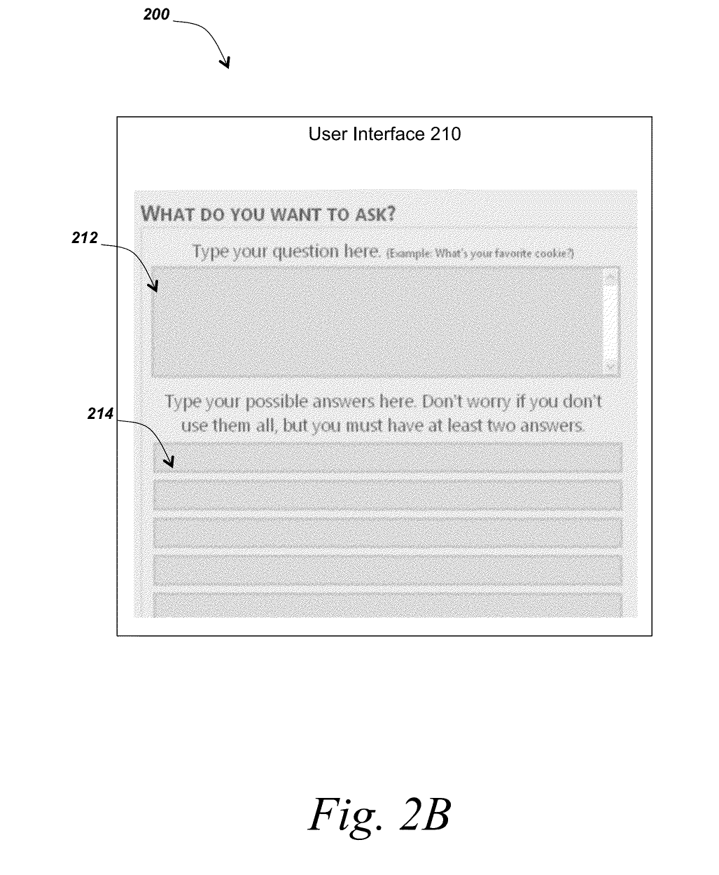

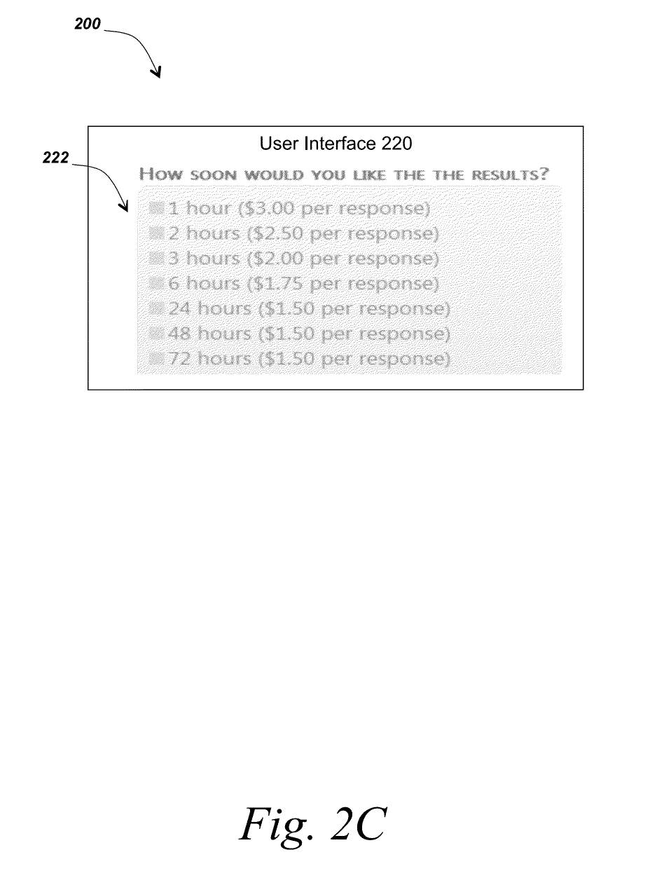

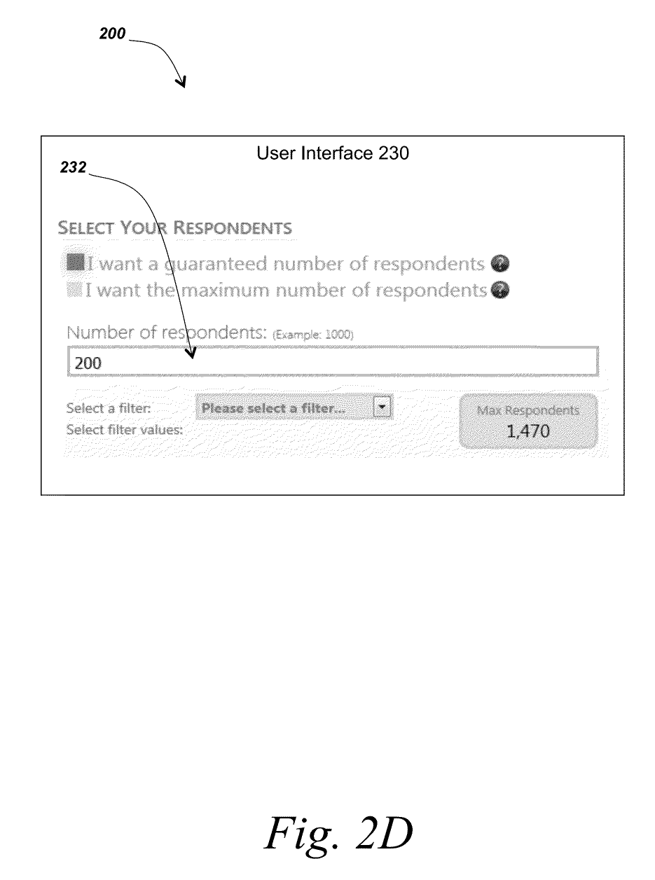

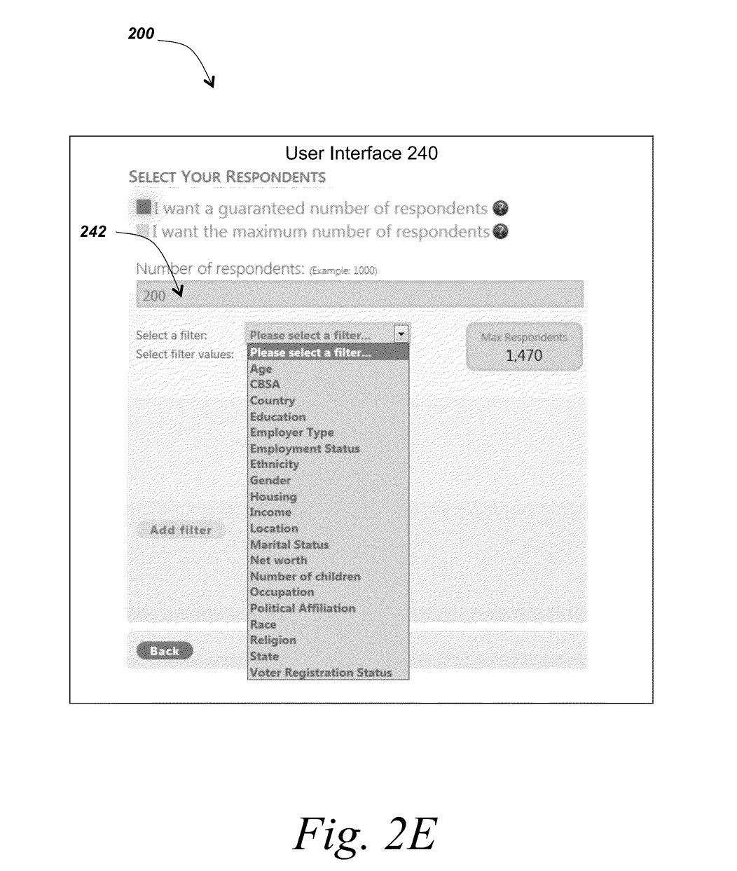

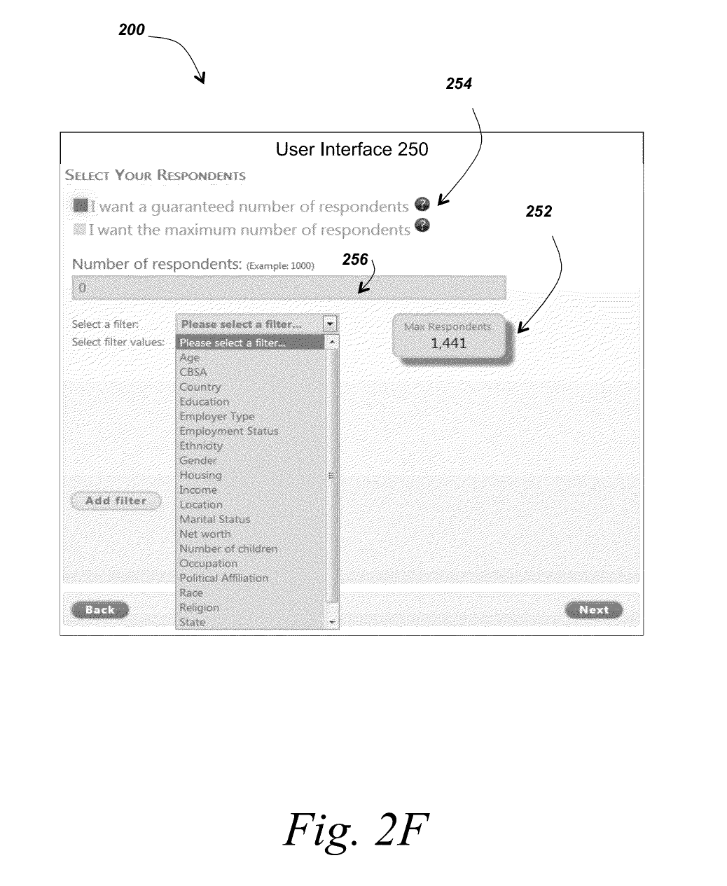

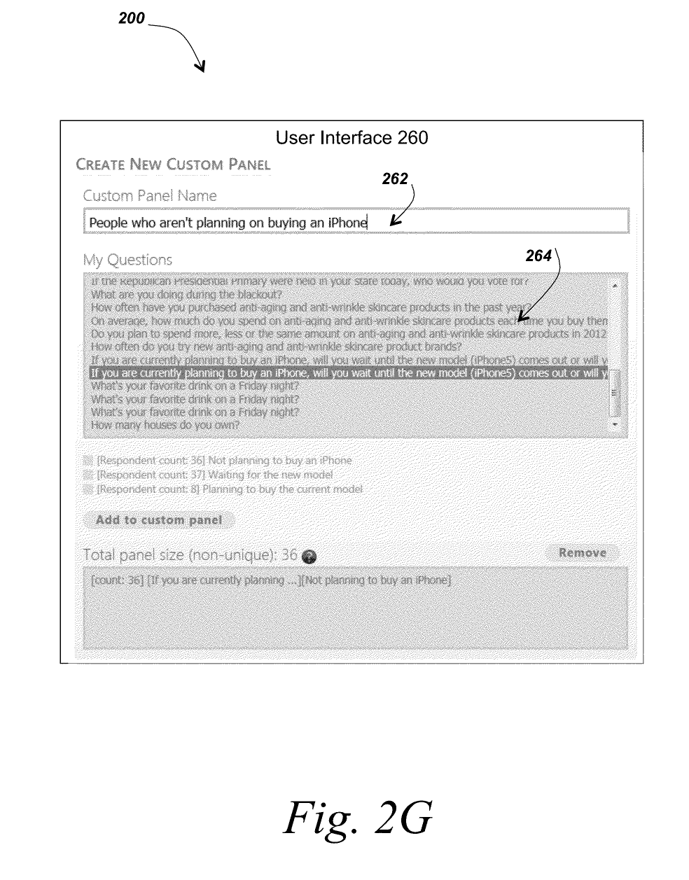

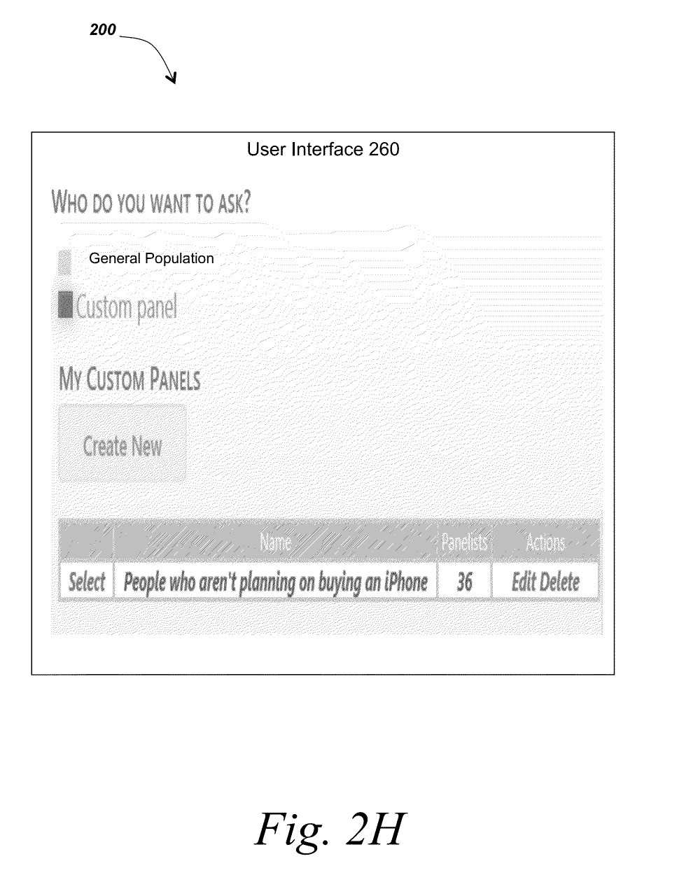

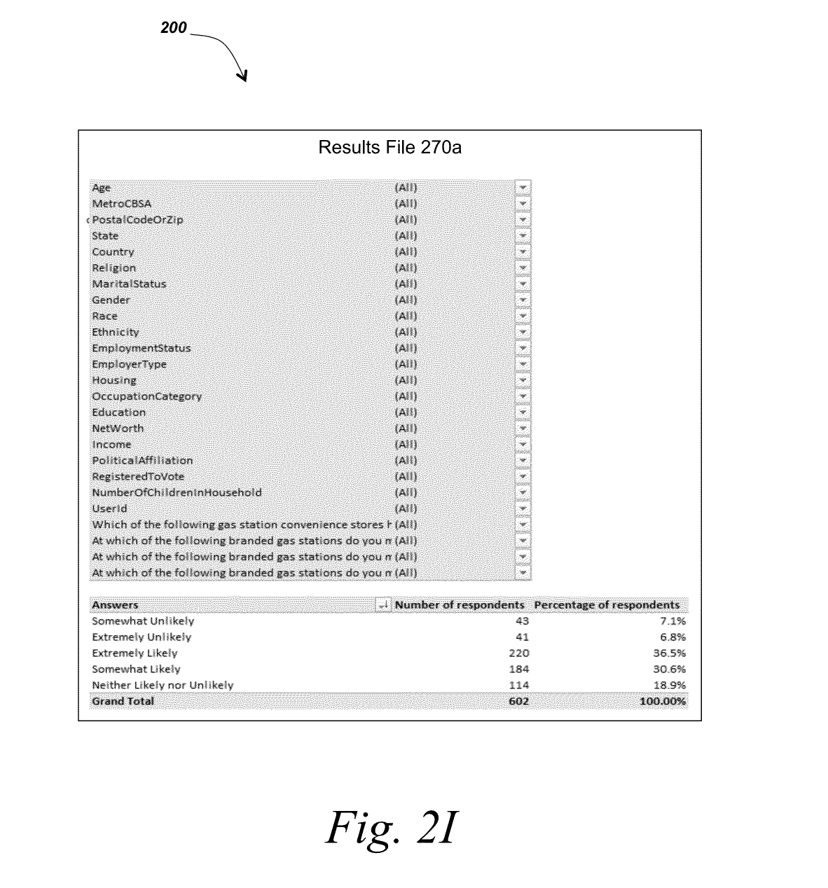

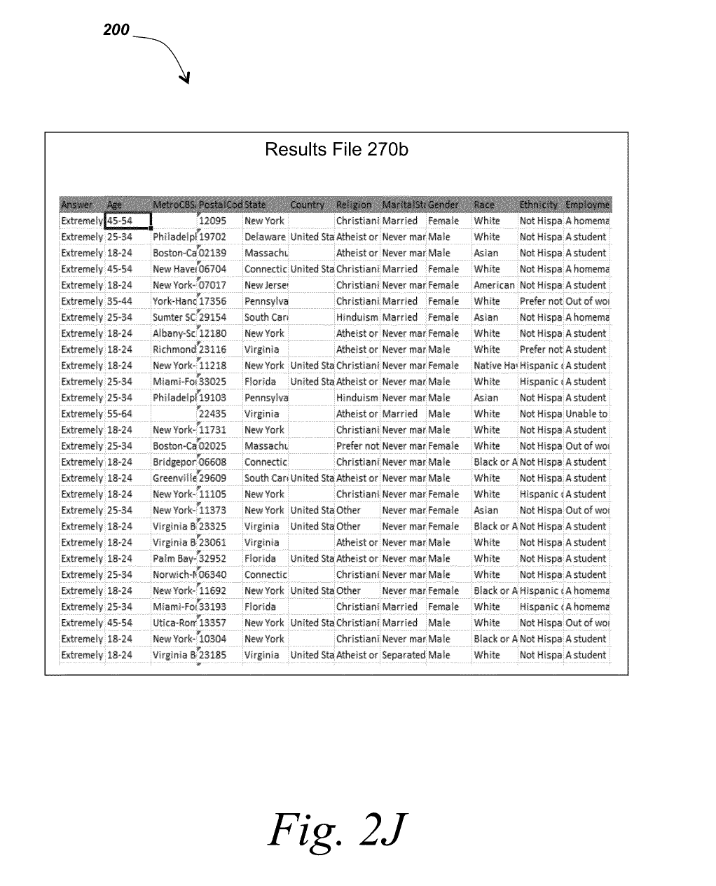

Referring now to FIG. 2A, a block diagram depicts one embodiment of a system for managing an online opinion survey service. In brief overview, the system includes a machine 106, a plurality of clients 102, a survey management system 202, a request management component 204, a panelist selection component 206, and a response compilation component 208. In some embodiments, the machine 106 and the clients 102a-d are machines provided as described above in connection with FIGS. 1A-1C. The machine 106 may be provided as an application server in communication with other servers, such as web servers (e.g., in a distributed system), or the machine 106 may provide all of the functionality required. The machine 106 may provide access to one or more remotely located databases and/or may store one or more databases locally.

In one embodiment, the survey management system 202 executes on the machine 106. In another embodiment, the survey management system 202 is provided as a software application. In still another embodiment, the survey management system 202 is provided as a hardware application. In another embodiment, the survey management system 202 includes a receiver; the receiver may receive data from a client 102 including, without limitation, a request for an online opinion survey and a response to an online opinion survey. In yet another embodiment, the survey management system 202 includes a transmitter; the transmitter may send data to a client 102 including, without limitation, a request to complete an online opinion survey, a response to an online opinion survey, and an analysis of a plurality of online opinion survey responses. The survey management system 202 may communicate with a web server 106b to receive requests for online opinion surveys. Alternatively, the machine 106 may provide the functionality of a web server and provide requests for online opinion surveys directly to the survey management system 202.

In one embodiment, the request management component 204 is provided as part of the survey management system 202. In another embodiment, the request management component 204 is provided as a stand-alone application in communication with the survey management system 202; such a stand-alone application may be provided either as a software application or a hardware application.

Referring now to FIG. 2B, a screen shot depicts one embodiment of a user interface for generating a request for an online opinion survey. In one embodiment, the request management component 204 provides the user interface 210 allowing a user of a client 102a to generate a request for an online opinion survey. In another embodiment, the user interface 210 includes an interface element 212 allowing the user of the client 102a to specify a question for inclusion in the online opinion survey. In still another embodiment, the user interface includes an interface element 214 allowing the user of the client 102a to specify a number of survey responses. In yet another embodiment, the user interface includes an interface element allowing the user of the client 102a to specify a response time within which the survey management system 202 should complete the online opinion survey and return the requested number of survey responses (not shown). In some embodiments, the request management component 204 provides functionality allowing a user of the client 102a to generate one question at a time. In other embodiments, the request management component 204 provides functionality allowing a user of the client 102a to generate a plurality of questions at one time.

In some embodiments, and referring now to FIG. 2C, the request management component 204 generates a second user interface 220 for specifying a requested response time. As shown in FIG. 2C, the second user interface 220 may include a user interface element 222 allowing the user of the client 102a to specify a response time within which the survey management system 202 should complete the online opinion survey and return the requested number of survey responses.

Referring now to FIG. 2D, a screen shot depicts one embodiment of a user interface for specifying a number of respondents for an online opinion survey. As shown in FIG. 2D, the request management component 204 may generate a user interface 230 including a user interface element 232 with which a user may specify a number of respondents for a requested online opinion survey.

Referring now to FIG. 2E, a screen shot depicts one embodiment of a user interface for specifying a requested characteristic for each of the number of respondents for an online opinion survey. As shown in FIG. 2E, the request management component 204 may generate a user interface 240 with which a user may specify one or more characteristics for each of a number of respondents for a requested online opinion survey. A user interface element 242 may list one or more characteristics with which the user may specify particular types of panelists to survey. As shown in FIG. 2E, and by way of example, without limitation, characteristics may include demographic information such as age, level of education, type of employer, employment status, ethnicity, gender, housing, income, geographic location, marital status, net worth, number of children, political affiliation, race, religion, and voter registration status.

Referring now to FIG. 2F, a screen shot depicts one embodiment of a user interface for indicating a number of available potential panelists satisfying user requests. As shown in FIG. 2F, the request management component 204 may generate a user interface 250 with which a user may specify characteristics for requested numbers of respondents for a requested online opinion survey. The user interface 250 may include a user interface element 254 with which a user may specify whether the number of respondents in the survey should be subject to a guaranteed number or should be the maximum that responds from a particular sub-section of the overall panel. By selecting the guaranteed number of respondents, the user chooses the number of respondents that are necessary to fulfill the order (which may be limited, for example, by a number of available respondents displayed in a user interface 252). By selecting the guaranteed number of respondents, the user also instructs the system to determine how many surveys must be sent out to generate the requested number of respondents (e.g., the system may determine that 800 panelists are required to guarantee 400 respondents). Alternatively, by selecting the maximum number of respondents, the user instructs the system to send the survey to as many respondents as the user specifies (e.g., in the field 256 labeled, in this embodiment, “Number of respondents”) and the user receives (and purchases) as many responses as are generated in the selected timeframe.

As indicated above, the user interface 250 may include a user interface element 252 displaying a number of available respondents. The user interface element 252 may dynamically modify the displayed number as the user modifies requested characteristics of potential panelists and of the survey. By way of example, if a user simply requests a survey, there may be 1400 panelists available and the user interface element 252 would display the number 1400; however, as the user adds additional requirements (e.g., requesting panelists of a certain gender, age, income level, and geographic location who are available to respond between particular times of day), the number of available panelists may change and the user interface element 252 may dynamically adjust the displayed number. In addition to modifying the displayed number of available panelists based on a user-selected filter, the system may apply other filters to dynamically adjust the displayed number. For example, the system may apply an algorithm to determine how many respondents the system can guarantee will respond, which may be lower than the total number of available respondents; based on that determination, the system may modify the number displayed in the user interface 252.

Referring now to FIG. 2G, a screen shot depicts one embodiment of a user interface for creating a customized panel of respondents. As shown in FIG. 2G, the user interface 260 may include an interface element 262 allowing a user to name a new custom panel of respondents. The user interface 260 may include an interface element 264 allowing a user to select a question previously posed to one or more panelists; the user may specify that respondent who provided a particular answer should be included in the new custom panel.

Referring now to FIG. 2H, a screen shot depicts one embodiment of a user interface in which the user chooses a custom panel of respondents to survey. As shown in FIG. 2H, the user is given the option of instructing the system to survey the respondents identified in a previously created custom panel. For example, the user may select a subset of all available panelists, where the subset includes those panelists whose previous answers qualify them for inclusion in the custom panel that the user has created using the interface represented in FIG. 2G. By selecting a custom panel, the user instructs the system to send a newly created question (e.g., a follow-up question) to those panelists included in the selected custom panel. In some embodiments in which a user creates a custom panel and a subsequent survey question to pose to a subset of panelists based on responses provided by the subset of panelists to previous questions, the creation of the custom panel and the subsequent survey question occurs after the subset of panelists have provided responses to previous questions. In other embodiments, the creation of the custom panel and the subsequent survey question occurs before any of the panelists have provided any responses; for example, a user may create a first survey question and specify, before the system surveys any panelists, that if any of the panelists should respond with a particular response, the system should automatically pose a second, subsequent question to the panelist. The first and second survey questions may relate to similar topics. Alternatively, the first and second survey questions may relate to different and/or dissimilar topics.

In some embodiments, no request management component 204 is provided. In one of these embodiments, the user of the client 102a instead provides the request information to an administrator of the survey management system 202 (e.g., via electronic mail, short message service, telephone, or an analog method of communication).

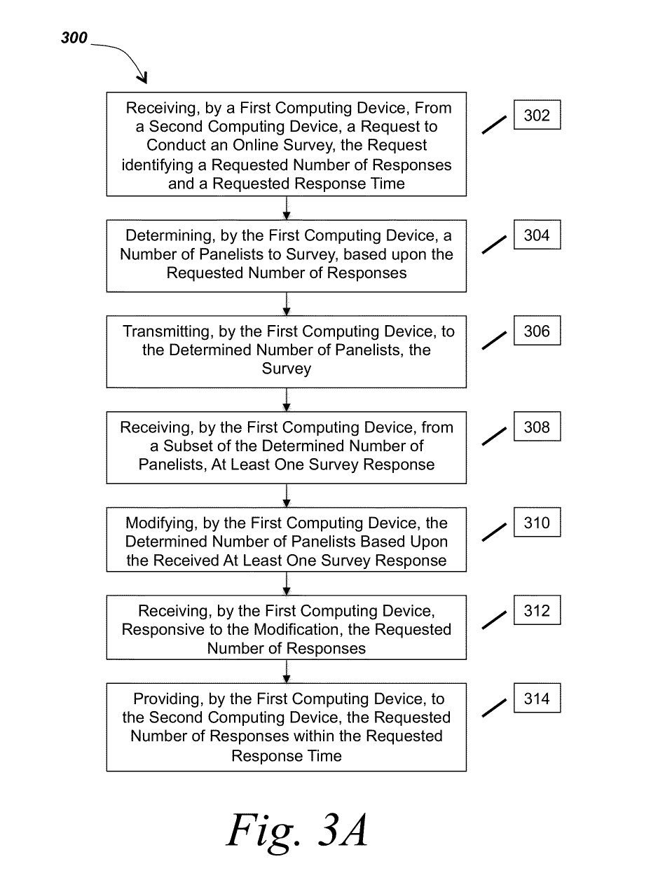

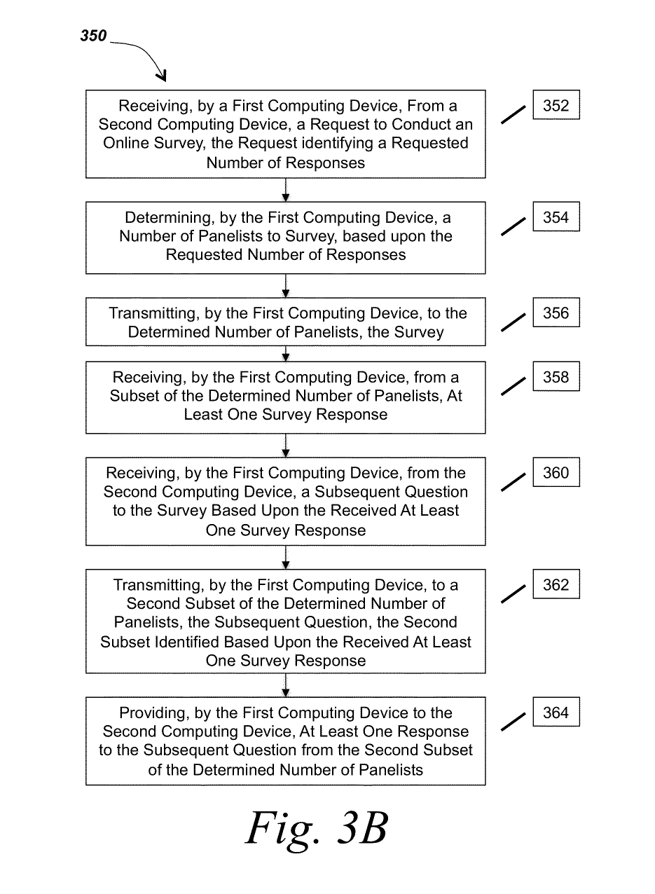

In one embodiment, the panelist selection component 206 is provided as part of the survey management system 202. In another embodiment, the panelist selection component 206 is provided as a stand-alone application in communication with the survey management system 202; such a stand-alone application may be provided either as a software application or a hardware application. In some embodiments, and as will be described in further detail in connection with FIGS. 3A-B below, the panelist selection component 206 determines a number of panelists to survey, based upon the requested number of responses. In some embodiments, the panelist selection component 206 has access to a database of available panelists (e.g., a database included on the machine 106 or accessible over a network 104).

In one embodiment, the response compilation component 208 is provided as part of the survey management system 202. In another embodiment, the response compilation component 208 is provided as a stand-alone application in communication with the survey management system 202; such a stand-alone application may be provided either as a software application or a hardware application. In some embodiments, and as will be discussed in further detail in connection with FIGS. 3A-B below, the response compilation component 208 includes functionality for compiling responses received from a plurality of clients 102. In other embodiments, and as will be discussed in further detail in connection with FIGS. 3A-B below, the response compilation component 208 includes functionality for analyzing compiled responses. In further embodiments, and as will be discussed in further detail in connection with FIGS. 3A-B below, the response compilation component 208 includes a transmitter for sending compiled responses to a client 102 that requested the online opinion survey.

Although the embodiment depicted in FIG. 2A shows the request management component 204, the panelist selection component 206, the response compilation component 208, and the entire survey management system 202 executing on a single machine 106, it should be understood that the survey management system 202 may be a distributed system with various sub-components executing on one or more machines 106a-n.

Referring ahead to FIG. 3A, a flow diagram depicts one embodiment of a method 300 for managing an online opinion survey service. In brief overview, the method 300 includes receiving, by a first computing device, from a second computing device, a request to conduct an online survey, the request identifying a requested number of responses and a requested response time (302). The method 300 includes determining, by the first computing device, a number of panelists to survey, based upon the requested number of responses (304). The method 300 includes transmitting, by the first computing device, to the determined number of panelists, the survey (306). The method 300 includes receiving, by the first computing device, from a subset of the determined number of panelists, at least one survey response (308). The method 300 includes modifying, by the first computing device, the determined number of panelists, based upon the received at least one survey response (310). The method 300 includes receiving, by the first computing device, responsive to the modification, the requested number of responses (312). The method 300 includes providing, by the first computing device, to the second computing device, the requested number of responses within the requested response time (314).

Referring now to FIG. 3A in greater detail, and in connection with FIG. 2A, the method 300 includes receiving, by a first computing device, from a second computing device, a request to conduct an online survey, the request identifying a requested number of responses and a requested response time (302). In one embodiment, and as discussed herein in connection with FIGS. 2B-2J, the survey management system 202 provides a user interface with which a user of the client 102 can submit the request; for example, the survey management system 202 may host a web page including the user interface. Via the user interface, a user of the client 102 can create a survey request. In one embodiment, the request management component 204 provides the user interface. In another embodiment, the user interface allows the user to draft the survey question and the relevant answer choices for that survey question and entering any accompanying text. Surveys may include one or more questions. Additionally, surveys may be limited to a particular number of questions. In still another embodiment, the user interface allows the user to specify a demographic, geographic, or socio-economic characteristic of the panelists that will be surveyed. In another embodiment, the user interface allows the user to specify a number of survey responses they require. In still another embodiment, the user interface allows the user to specify follow-up questions to be asked of panelists in particular situations to be specified by the user (e.g., questions to be asked in the event that a panelist provides a particular response to a previous question). In yet another embodiment, the user interface allows the user to specify a timeframe in which the survey management system 202 should provide the survey responses. Once submitted by the client 102a, this information, which includes the client request data, may be stored in a database accessible to the survey management system 202.

The method 300 includes determining, by the first computing device, a number of panelists to survey, based upon the requested number of responses (304). In one embodiment, the machine 106 determines the number of panelists to survey, based upon the requested number of responses. In another embodiment, the machine 106 determines the number of panelists to survey, based upon both the requested number of responses and the requested response time. In still another embodiment, the survey management system 202 determines the number of panelists to survey. In another embodiment, the panelist selection component 206 determines the number of panelists to survey.

In one embodiment, the panelist selection component 206 identifies an initial number of panelists to survey. In another embodiment, the panelist selection component 206 determines a survey-response rate for the current survey based upon historical data. For example, and without limitation, the panelist selection component 206 may analyze an amount of elapsed time after sending a previously-completed survey to at least one panelist and a corresponding response rate over the identified amount of elapsed time to determine a historical survey-response rate. By way of example, and without limitation, for each historical survey available to the panelist selection component 206, the panelist selection component 206 generates a set of data points (x, y), where the x-coordinate represents the number of minutes elapsed after sending a survey question to the panelists and the y-coordinate represents the response rate, which is the total number of survey responses received at that time divided by the total number of surveyed panelists. In still another embodiment, the panelist selection component 206 generates an average historical survey-response rate. By way of example, given a set of data points (x, y) for each of a plurality of historical surveys, the panelist selection component 206 calculates the average or mean of the y-values for each x-value. In another embodiment, the panelist selection component 206 calculates an estimated response rate for a survey given an elapsed period of time since the panelists were surveyed. By way of example, and without limitation, given a set of data points (x, y) and a calculated average of y-values for each x-value, in one embodiment, and without limitation, the panelist selection component 206 fits a least squares logarithmic regression over these points, resulting in a logarithmic equation of the form y=a*ln(x)+b, where y represents the estimated response rate for a survey question given an elapsed amount of time (e.g., minutes) since the panelists were surveyed, x. In yet another embodiment, the panelist selection component 206 uses the estimated response rate for the survey given the elapsed period of time since the survey. For example, and without limitation, the panelist selection component 206 may use a logarithmic equation to calculate a number of panelists to send the current survey question to (N) by dividing the number of survey responses the client requests by the estimated response rate (a*ln(x)+b), where x is the number of minutes requested by the client for fulfillment of their survey responses. Although described in the examples above as implementing a logarithmic regression, the panelist selection component 206 may implement any algorithm that allows for the calculation of a response rate; logarithmic regression is just one example. Additionally, any number of independent variables may be used in determining the response rate; for example, the panelist selection component 206 may also calculate specific response rates based on particular geographies, panelist demographics, times of day, or other survey variables.

The method 300 includes transmitting, by the first computing device, to the determined number of panelists, the survey (306). In one embodiment, having determined the number of initial panelists to survey, the panelist selection component 206 selects specific panelists for the survey. In another embodiment, the panelist selection component 206 accesses a database of panelists to select specific panelists. In still another embodiment, the panelist selection component 206 retrieves information from the request management component 204 to complete the selection process; for example, the request management component 204 may have received an identification of a particular characteristic that the user of the client 102 requested each panelist have. In yet another embodiment, the panelist selection component 206 identifies a plurality of panelists who meet the demographic, geographic, and socio-economic criteria requested by the user of the client 102a.

In some embodiments, there are more panelists who meet the requested criteria than the determined number of panelists to be surveyed. In one of these embodiments, the panelist selection component 206 assigns a random number to each of the plurality of panelists that satisfy the requested criteria. In another of these embodiments, the panelist selection component 206 arranges the plurality of panelists from smallest to largest according to the random numbers and selects the first N panelists from this list to survey.

In some embodiments, the panelist selection component 206 selects panelists that have completed a verification process. In one of these embodiments, the panelist selection component 206 confirms that each panelist is a unique person (e.g., that no one person has signed up more than once). In another of these embodiments, the panelist selection component 206 uses a third-party service to verify that each panelist has only signed up once to answer a survey. For example, the panelist selection component 206 may request that a potential panelist be verified by a third-party verification system before selecting the potential panelist. As an example, the panelist selection component 206 may use an application programming interface to provide functionality that (i) allows a potential panelist to provide the third-party service with credentials for a user account with the third-party service and (ii) allows the third-party service to indicate to the panelist selection component 206 that the potential panelist is a verified user of the third-party service. By way of example, and without limitation, the panelist selection component 206 may request that a potential panelist log in to an account previously established with a service such as that provided by PayPal, Inc. of San Jose, Calif., and request that PayPal, Inc. provide the panelist selection component 206 with verification that the potential panelist is a verified PAYPAL user. In some embodiments, implementation of such a system allows the panelist selection component 206 to leverage pre-existing accounts with a third-party to confirm that there are no duplicate users in the pool of potential panelists without requiring the system 200 to establish a separate account system or to maintain sensitive user data (such as, for example, bank account data). In some embodiments, the verification process occurs at any time before selection of a panelist as one of a determined number of panelists to whom the survey will be transmitted. In one embodiment, the verification process occurs when a potential panelist indicates an interest in being considered as a potential panelist (e.g., by joining a service maintained by the system 200). In such an embodiments, when clients are selecting panelists to survey, they have access to descriptions of already-verified potential panelists (e.g., when a number of available respondents is displayed in a user interface 252 as shown in FIG. 2F, those are potential panelists who have already been verified).

In one embodiment, the panelist selection component 206 transmits the survey to the selected panelists. In another embodiment, the panelist selection component 206 directs the survey management system 202 to transmit the survey. In still another embodiment, the panelist selection component 206 directs the machine 106 to transmit the survey. In yet another embodiment, the panelist selection component 206 directs the transmission of the survey via electronic communication (e.g., electronic mail message or short message service). In some embodiments, transmitting the survey includes transmitting survey answer choices. In other embodiments, transmitting the survey includes transmitting instructions regarding how to answer the question and a timeframe in which to respond to the survey.

In some embodiments, the survey management system 202 includes functionality enabling panelists to answer survey questions directly from their electronic mail (“email”) accounts. In one of these embodiments, for certain question types, panelists select their preferred answer choice in a body of an email received from the survey management system 202. In another of these embodiments, and by way of example, when a user of a client 102b receives the email and selects their answer, data indicating the selection is sent to the survey management system 202. In still another of these embodiments, the response compilation component 208 receives the data indicating the selection. In another of these embodiments, the response compilation component 208 stores the data indicating the selection with data associated with the panelist (e.g., demographic, geographic and socio-economic data). In still another of these embodiments, panelists can respond to the survey without needing to complete a log-in process with the survey management system 202. For example, each panelist may receive a customized email including a customized uniform resource locator (URL) for each of the available answer options in the survey; the customized URL associated with selecting the first option in answering a question by a first panelist may be different than the customized URL associated with selecting the first option in answering the same question by a second panelist. As another example, the customized URL may execute a command that automatically transmits an identification of the answer selected and an identification of the panelist to the survey management system 202. As a further example, the customized URL may execute a command to open a browser and download a web page from the survey management system 202 allowing the respondent to confirm their selection.

The method 300 includes receiving, by the first computing device, from a subset of the determined number of panelists, at least one survey response (308). In one embodiment, the response compilation component 208 receives the at least one survey response. In another embodiment, the survey management system 202 actively manages a survey question response rate by dynamically adjusting the number of panelists who receive the survey question. In still another embodiment, the response compilation component 208 identifies a number of survey responses received during a period of time after the initial transmission of survey questions to panelists. In yet another embodiment, the response compilation component 208 transmits the identification of the number of survey responses received to the panelist selection component 206.

The method 300 includes modifying, by the first computing device, the determined number of panelists, based upon the received at least one survey response (310). In one embodiment, the panelist selection component 206 determines a real-time response rate based upon the identified number of received survey responses. By way of example, the panelist selection component 206 may calculate the real-time response rate by dividing the identified number of received survey responses by the number of panelists originally surveyed. In another embodiment, the panelist selection component 206 compares the calculated real-time response rate to an estimated response rate; for example, by comparing the calculated real-time response rate to the estimated response rate identified as described above in connection with (304). In still another embodiment, the panelist selection component 206 determines whether to modify the determined number of panelists based upon the comparison of the real-time response rate to the estimated response rate. In another embodiment in which the real-time response rate is lower than the estimated response rate, the panelist selection component 206 determines to identify and transmit the survey to additional qualifying panelists. In an embodiment in which the real-time response rate is higher than the estimated response rate, the panelist selection component 206 determines not to modify the determined number of panelists.

In some embodiments, the survey management system 202 analyzes a number of received survey responses to determine whether or not to modify the determined number of panelists a plurality of times during a particular response time. In one of these embodiments, for example, and without limitation, if a user of the client 102a requested 20 responses in 20 minutes, and the panelist selection component 206 initially determined that 40 panelists should be surveyed, the survey management system 202 may instruct the panelist selection component 206 to determine whether to modify the determined number of panelists every five minutes after the transmission of the survey, or every 10 minutes, or at a predetermined number of intervals.

The method 300 includes receiving, by the first computing device, responsive to the modification, the requested number of responses (312). In one embodiment, in order to receive the requested number of responses, the initial number of panelists requires modification; for example, if the survey request included a request for 300 responses in 2 hours but at the 30-minute mark only 50 responses had been received, without modification the response compilation component 208 might not receive the requested number of responses.

In one embodiment, the response compilation component 208 compiles the received survey responses. In another embodiment, the response compilation component 208 compiles the received survey responses after the requested response time has elapsed. In still another embodiment, the response compilation component 208 compiles a report identifying a response received from each surveyed panelist. For example, and without limitation, after the client-defined timeframe has elapsed, the response compilation component 208 may compile the received survey responses into a spreadsheet in which each row represents a specific panelist while each column holds information about that panelist, including their response to the survey question and their demographic, geographic, socio-economic, and other characteristics. The response compilation component 208 may provide additional respondent data such as panelist responses to previous questions asked by the client. The response compilation component 208 may also provide additional data visualization elements, including, without limitation, graphs and charts.

As another example, the response compilation component 208 may populate a particular type of spreadsheet to facilitate analysis of the survey response data, such as, without limitation, a pivot table, which may be provided, without limitation, as a MICROSOFT EXCEL PIVOTTABLE. In a further example, the response compilation component 208 may provide the data in a format the client can use to enter the data into a third-party system or may provide functionality for transmitting the data directly into third-party systems (such as, without limitation, a relationship management system).

Referring back to FIG. 2I, and in connection with FIG. 3A, a screen shot depicts one embodiment of a results file including a pivot table, the results file provided by the response compilation component 208. In one embodiment, the results file 270a includes at least one pre-formatted pivot table analytical tool for analyzing the survey's results, including, without limitation, by filtering those results by the available demographic, geographic, and socio-economic characteristics of the respondents, as well as by the previous answers given by those respondents to other questions ordered by the same client, in the event that the client has used the “Custom Panel” feature of the interface. The results file 270a may be provided to the user who ordered the survey electronically (e.g., via email or in a client-accessible web page).

Referring again to FIG. 3A, and in some embodiments, the response compilation component 208 includes functionality for analyzing the received survey responses. In one of these embodiments, the response compilation component 208 provides a MICROSOFT EXCEL spreadsheet of the results formatted so that users can manipulate the data and analyze it using the variety of demographic, geographic, and socio-economic filters that the survey management system 202 provides. In addition to providing a user with received survey responses for analysis, the response compilation component 208 may also provide the user with received responses from previous surveys. In another of these embodiments, the response compilation component 208 includes functionality for generating a summary of the types of responses received.

Referring back to FIG. 2J, and in connection with FIG. 3A, a screen shot depicts one embodiment of a results file provided by the response compilation component 208. In one embodiment, a results file 270b is a spreadsheet, which may be provided in an electronic format such as, for example, a MICROSOFT EXCEL file. In another embodiment, the results file 270b includes demographic, geographic, and socio-economic characteristics of each respondent. In another embodiment, the results file 270b includes each respondent's answer to a survey question. In still another embodiment, the results file 270b includes each respondent's answers to other survey questions asked by the user who ordered that survey. In yet another embodiment, the results file 270b is provided to the user who ordered the survey electronically (e.g., via email or in a client-accessible web page). Although FIGS. 2I and 2J depict embodiments in which the results file provides data in a particular format, it should be understood that these embodiments are merely illustrative and not limiting. For example, in another embodiment, the results file provides access to data in a raw format (e.g., XML or JSON) instead of in any particular type of spreadsheet or pivot table.

Referring again to FIG. 3A, the method 300 includes providing, by the first computing device, to the second computing device, the requested number of responses within the requested response time (314). In one embodiment, the response compilation component 208 transmits, to the client 102a, the requested number of responses within the requested response time. In another embodiment, the response compilation component 208 directs the transmission of the compiled responses via electronic communication (such as, without limitation, email).

In some embodiments, the panelist selection component 206 analyzes the determined number of panelists, any modifications to the determined number of panelists, and the final number of responses and respondents. In one of these embodiments, the panelist selection component 206 uses this data and the analysis of the data as historical data in generating future numbers of panelists (e.g., contributing the resulting data to historical data used in generating survey-response rates). In another of these embodiments, the panelists selection component 206 uses this data to improve the process, described in connection with (304) and (310) above, of modifying the determined number of panelists in future surveys.

Referring now to FIG. 3B, a flow diagram depicts one embodiment of a method for generating subsequent survey questions in connection with an online opinion survey service. The method 350 includes receiving, by a first computing device, from a second computing device, a request to conduct an online survey, the request identifying a requested number of responses (352). The method 350 includes determining, by the first computing device, a number of panelists to survey, based upon the requested number of responses (354). The method 350 includes transmitting, by the first computing device, to the determined number of panelists, the survey (356). The method 350 includes receiving, by the first computing device, from a subset of the determined number of panelists, at least one survey response (358). The method 350 includes receiving, by the first computing device, from the second computing device, a subsequent question to the survey based upon the received at least one survey response (360). The method 350 includes transmitting, by the first computing device, to a second subset of the determined number of panelists, the subsequent question, the second subset identified based upon the received at least one survey response (362). The method 350 includes providing, by the first computing device to the second computing device, at least one response to the subsequent question from the second subset of the determined number of panelists (364).

The method 350 includes receiving, by a first computing device, from a second computing device, a request to conduct an online survey, the request identifying a requested number of responses (352). In one embodiment, the first computing device receives the request as described above in connection with FIG. 3A. The method 350 includes determining, by the first computing device, a number of panelists to survey, based upon the requested number of responses (354). In one embodiment, the first computing device determines the number of panelists as described above in connection with FIG. 3A.

The method 350 includes transmitting, by the first computing device, to the determined number of panelists, the survey (356). In one embodiment, the first computing device transmits the survey as described above in connection with FIG. 3A. The method 350 includes receiving, by the first computing device, from a subset of the determined number of panelists, at least one survey response (358). In one embodiment, the first computing device receives the at least one survey response as described above in connection with FIG. 3A.

The method 350 includes receiving, by the first computing device, from the second computing device, a subsequent question to the survey based upon the received at least one survey response (360). For example, the system 200 may receive (e.g., via the user interface 210 discussed above in connection with FIG. 2B), the subsequent question.

The method 350 includes transmitting, by the first computing device, to a second subset of the determined number of panelists, the subsequent question, the second subset identified based upon the received at least one survey response (362). In one embodiment, the first computing device analyzes the received at least one survey response. For example, the first computing device may analyze the at least one survey response to identify the second subset of the determined number of panelists. As another example, the first computing device may analyze the at least one survey response to automatically identify a subsequent question to transmit to the second subset of the determined number of panelists. In some embodiments, a user of the client 102a identifies the second subset of the determined number of panelists; for example, the user may generate a customized panel as discussed above in connection with FIGS. 2G and 2H.

The method 350 includes providing, by the first computing device to the second computing device, at least one response to the subsequent question from the second subset of the determined number of panelists (364).

In some embodiments, the methods and systems described herein provide functionality for managing an online opinion survey service. In one embodiment, implementation of the methods and systems described herein permit a client 102a to initiate an opinion survey service in a fully automated, “do-it-yourself” environment providing a user of the client 102a with the ability to choose a desired number of survey respondents, configure the panel of those survey respondents to reflect the particular demographic, geographic, socio-economic, and/or behavioral characteristics of the user's choosing, and to select a specific time limit for the survey which will determine the turnaround time of the entire survey. In another of these embodiments, the survey management system 202 provides this functionality in an automated fashion, without the user having to understand anything of the response rates necessary to facilitate the completion of the survey in the chosen time period. Accordingly, unlike conventional online opinion survey services that typically require extensive programming and logistical coordination between the survey administrator and the user, and unlike conventional market research providers which may require periodic updates with the user in order to guarantee that the survey is completed to the user's requested parameters, the methods and systems described herein allow users to write and launch online opinion surveys with complete independence from the survey administrator, maximizing the speed and reducing the time and labor costs of the survey overall. In yet another of these embodiments, implementation of the methods and systems described herein enables the user to create and launch surveys of customized panels of respondents, based on previous answers given by those respondents to questions asked by the user. In yet another of these embodiments, implementation of the methods and systems described herein enables a survey administrator to guarantee its panelists that they will be compensated if they answer a survey question within a stated time period; such a guarantee is a significant and attractive part of the survey administrator's value proposition put forward to potential panelists and allows the survey administrator to build an ever-larger panel of potential respondents, which in turn can be used to burnish the value proposition put forward to potential clients.

It should be understood that the systems described above may provide multiple ones of any or each of those components and these components may be provided on either a standalone machine or, in some embodiments, on multiple machines in a distributed system. It should also be understood that phrases such as “based on” and “based upon” do not imply “based exclusively on” and instead generally mean that the particular feature, structure, step, or characteristic is based at least in part on the specified element. Further, the phrases ‘in one embodiment,’ ‘in another embodiment,’ and the like, generally mean that the particular feature, structure, step, or characteristic following the phrase is included in at least one embodiment of the present disclosure and may be included in more than one embodiment of the present disclosure. However, such phrases do not necessarily refer to the same embodiment.

Although FIGS. 2B-2J depict certain embodiments of interfaces for use in connection with the system 200, it should be understood that these are provided as examples and not intended to be limiting; alternative embodiments of interfaces may be implemented to provide the functionality described above. For example, the system 200 may provide an application programming interface with which a user of a client 102a may access the functionality of the system 200; in such an example, the system 200 need not also provide the various user interfaces and results files described in FIGS. 2B-2J.

The systems and methods described above may be implemented as a method, apparatus, or article of manufacture using programming and/or engineering techniques to produce software, firmware, hardware, or any combination thereof. The techniques described above may be implemented in one or more computer programs executing on a programmable computer including a processor, a storage medium readable by the processor (including, for example, volatile and non-volatile memory and/or storage elements), at least one input device, and at least one output device. Program code may be applied to input entered using the input device to perform the functions described and to generate output. The output may be provided to one or more output devices.

Each computer program within the scope of the claims below may be implemented in any programming language, such as assembly language, machine language, a high-level procedural programming language, or an object-oriented programming language. The programming language may, for example, be LISP, PROLOG, PERL, Python, C, C++, C#, JAVA, Ruby, or any compiled or interpreted programming language.

Each such computer program may be implemented in a computer program product tangibly embodied in a machine-readable storage device for execution by a computer processor. Method steps of the invention may be performed by a computer processor executing a program tangibly embodied on a computer-readable medium to perform functions of the invention by operating on input and generating output. Suitable processors include, by way of example, both general and special purpose microprocessors. Generally, the processor receives instructions and data from a read-only memory and/or a random access memory. Storage devices suitable for tangibly embodying computer program instructions include, for example, all forms of computer-readable devices, firmware, programmable logic, hardware (e.g., integrated circuit chip, electronic devices, a computer-readable non-volatile storage unit, non-volatile memory, such as semiconductor memory devices, including EPROM, EEPROM, and flash memory devices; magnetic disks such as internal hard disks and removable disks; magneto-optical disks; and CD-ROMs). Any of the foregoing may be supplemented by, or incorporated in, specially-designed ASICs (application-specific integrated circuits) or FPGAs (Field-Programmable Gate Arrays). A computer can generally also receive programs and data from a storage medium such as an internal disk (not shown) or a removable disk. These elements will also be found in a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium. A computer may also receive programs and data from a second computer providing access to the programs via a network transmission line, wireless transmission media, signals propagating through space, radio waves, infrared signals, etc.

Having described certain embodiments of methods and systems for managing an online opinion survey service, it will now become apparent to one of skill in the art that other embodiments incorporating the concepts of the disclosure may be used. Therefore, the disclosure should not be limited to certain embodiments, but rather should be limited only by the spirit and scope of the following claims.

What is claimed is:

1. A method for managing an online survey, the method comprising:
receiving, by a first computing device, from a second computing device, a request to conduct an online survey, the request identifying a requested number of responses and a requested response time;
determining, by the first computing device, a number of panelists to survey, based upon the requested number of responses;
transmitting, by the first computing device, to the determined number of panelists, the survey;
receiving, by the first computing device, from a subset of the determined number of panelists, at least one survey response;
modifying, by the first computing device, the determined number of panelists based upon the received at least one survey response;
receiving, by the first computing device, responsive to the modification, the requested number of responses; and
providing, by the first computing device, to the second computing device, the requested number of responses within the requested response time.

2. The method of claim 1, wherein receiving the request to conduct the online survey further comprises receiving a requested panelist characteristic.

3. The method of claim 2, wherein determining further comprises determining a number of panelists having the requested panelist characteristic based upon the requested number of responses and the requested panelist characteristic.

4. The method of claim 2 further comprising providing to the second computing device, for display to a user of the second computing device, a user interface element displaying a number of available panelists having the requested panelist characteristic.

5. The method of claim 1, wherein determining further comprises determining, by the first computing device, the number of panelists to survey, based upon the requested number of responses and the requested response time.

6. The method of claim 1, wherein determining further comprises determining, by the first computing device, a survey-response rate for the current survey based upon a historical survey response rate.

7. The method of claim 6 further comprising analyzing an amount of elapsed time after sending a previously completed survey to at least one panelist and a corresponding response rate over the identified amount of elapsed time to determine the historical survey response rate.

8. The method of claim 1, wherein transmitting further comprises transmitting, by the first computing device, to a plurality of computing devices, the survey, each of the plurality of computing devices associated with one of the determined number of panelists.

9. The method of claim 1, wherein transmitting further comprises transmitting, by the first computing device, to a plurality of computing devices, an electronic mail message including the survey, each of the plurality of computing devices associated with one of the determined number of panelists.

10. The method of claim 1, wherein modifying further comprises:
calculating a real-time response rate based upon an identified number of received survey responses and the number of panelists originally surveyed;
comparing the real-time response rate to an estimated response rate; and
determining to modify the determined number of panelists based upon the comparison.

11. The method of claim 1 further comprising analyzing, by the first computing device, the received number of responses.

12. The method of claim 11 further comprising providing, by the first computing device, to the second computing device, the analysis.

13. A method for generating subsequent survey questions in connection with an online opinion survey service, the method comprising:
receiving, by a first computing device, from a second computing device, a request to conduct an online survey, the request identifying a requested number of responses;
determining, by the first computing device, a number of panelists to survey, based upon the requested number of responses;
transmitting, by the first computing device, to the determined number of panelists, the survey;
receiving, by the first computing device, from a subset of the determined number of panelists, at least one survey response;
receiving, by the first computing device, from the second computing device, a subsequent question to the survey based upon the received at least one survey response;
transmitting, by the first computing device, to a second subset of the determined number of panelists, the subsequent question, the second subset identified based upon the received at least one survey response; and
providing, by the first computing device to the second computing device, at least one response to the subsequent question from the second subset of the determined number of panelists.

14. The method of claim 13 further comprising analyzing the received at least one survey response.

15. The method of claim 14 further comprising identifying the second subset of the determined number of panelists based upon the analysis.

16. A system for managing an online survey, the system comprising:
means for receiving, by a first computing device, from a second computing device, a request to conduct an online survey, the request identifying a requested number of responses and a requested response time;
means for determining, by the first computing device, a number of panelists to survey, based upon the requested number of responses;
means for transmitting, by the first computing device, to the determined number of panelists, the survey;
means for receiving, by the first computing device, from a subset of the determined number of panelists, at least one survey response;
means for modifying, by the first computing device, the determined number of panelists based upon the received at least one survey response;
means for receiving, by the first computing device, responsive to the modification, the requested number of responses; and
means for providing, by the first computing device, to the second computing device, the requested number of responses within the requested response time.
